(19) United States
(12) Patent Application Publication
(10) Pub. No.: US 2011/0238334 A1
(43) Pub. Date: Sep. 29, 2011

(54) ARRANGEMENT RELATED TO A GAS SENSOR

(75) Inventor: Hans Goran Evald Martin, Delsbo (SE)

(73) Assignee: SENSEAIR AB, Delsbo (SE)

(21) Appl. No.: 13/132,093

(22) PCT Filed: Dec. 4, 2009
(86) PCT No.: PCT/SE2009/051375

§ 371 Date: Jun. 1, 2011

(30) Foreign Application Priority Data
Dec. 12, 2008 (SE) 0802562-9

(51) Int. Cl. G06F 19/00

(52) U.S. Cl. 702/50

(57) ABSTRACT

A gas-sensor related arrangement and more specifically an arrangement which, for its function, utilizes a first light-generating element, a second light-receiving element, and a third element for forming and defining an optical measuring distance between the first and second elements through a gas sample, as well as a control unit, with associated calculating circuits. More specifically, a unit is to be allotted to a plurality of first electric connector devices or elements. The connector devices are adapted and distributed along a first surface portion of the unit for an electric connecting possibility to other electric connector devices or elements related to a carrier, such as a printed circuit card or board, for the unit. The first and second elements are to be closely related to each other within a discrete unit as a first and a second surface section. The discrete unit is shaped and dimensioned so as to exhibit a small thermal mass. The entire, or at least a part, of a memory circuit, the entire, or at least a part, of the control unit, with all or chosen associated calculating circuits, are to be coordinated in the discrete unit and to be, over an internal wiring coordinated with the discrete unit, connected to chosen first electric connector devices.

### TECHNICAL FIELD OF THE INVENTION

This invention generally refers to an arrangement related to a gas sensor and specifically to an arrangement which for its function utilizes a first means for generating light, a second means for receiving light, and a third means for forming and defining an optical measuring distance, between said first and second means, and through a sample of gas as well as an electronic control unit with its associated memory circuits and calculating circuits and a display or a corresponding means for a presentation of and utilizing a result which has been calculated.

Said first, second and third means can be coordinated into a single unit.

More specifically, such unit can be associated with a plurality of first electric connectors, said connectors being adapted and distributed along a first surface portion of said unit in order to offer the possibility of an electric connection to other electric connectors, wherein said other connectors are to be related to a carrier or corresponding structure, such as a printed circuit card for said unit.

Said first and second means are primarily shaped as individual circuit arrangements of said unit and are then normally to be oriented on opposite sides of and optically cooperating with said third means.

Over connectors the unit is to be able to cooperate electrically with or to comprise a control unit of a structure known per se in order to generate, over the control unit, electric pulses to and for activating said first means and for, over the control unit, receiving light pulses for activating said second means and for analysing a received pulse structure within the control unit in response to said first means being activated and the structure thereof, for evaluating and/or analysing the gas content and/or contents in a sample of gas with the aid of memory circuits and/or calculating circuits, related to the control unit with regard to and utilizing a spectral analysis known per se in the prior art.

### BACKGROUND OF THE INVENTION

Methods, arrangements and structures related to the above-mentioned technical field and having a function and a structure, which fulfill requirements set up are known earlier in a plurality of different embodiments.

As a first example of the background of technology and the technical field to which the invention refers, a gas-sensor related arrangement presently on the market may be mentioned, basically mounted on a circuit card, according to the following FIG. 1, and having discrete components of simple type connected to the circuit card.

An arrangement related to a gas sensor shown and described here utilizes for its function a first means for generating light, a second means for receiving light, and a third means for forming and defining an optical measuring distance or path between said first means and said second means through a sample of gas as well as a control unit with associated memory circuits and/or calculating circuits with regard to a performed spectral analysis.

Said first, second, and third means are here coordinated to a restricted surface section of the circuit card.

More specifically the possibility is indicated here of letting said circuit card be associated with a first plurality of electric connectors, said connectors being adapted and distributed along a first surface portion of said circuit card, for enabling offering of the possibility of electric connections to other electric connectors related to an adjacent circuit card, wherein said first and said second means to advantage may be shaped or formed as circuit arrangements and disposed on opposite sides of a third means bent as a portion of an arc of a circle (part of a torus) and open for receiving and/or leaving a relevant sample of gas.

The functional units of the circuit card can cooperate electrically with a utilized control unit of a structure known per se over different connectors for generating electric pulses over the control unit to and for activating said first unit and for receiving thus generated light pulses in a second means and analyzing the received pulse structure in the control unit and its calculating circuits for evaluating and/or analysing the gas content of the sample of gas, while utilizing a complicated spectral analysis process.

In considering the peculiarities related to the present invention, it should also be mentioned that it is known in the prior art to create similar and different and more or less complex circuit arrangements with different technologies on selected surface sections of a printed circuit card and/or a printed board.

Furthermore, it is known earlier, in different types of control units for different control or analysing systems to have a computer unit sensitive to and processing different input data in calculating circuits and with the assistance of memory circuits to generate output data in response to one or more utilized algorithms in the calculating circuits and one or more utilized software applications.

In such control units it is known in the prior art to distribute the different functions and/or function units of the calculating circuits and the required memory capacity of the memory circuits to different sets of printed circuit cards and to connect, over different connectors and/or manufacturing processes, the connector of a first printed circuit card electrically with connectors of one or more other printed circuit cards.

Taken into consideration the technical evaluations linked to the present invention the following Patent Publications are to be mentioned as part of the earlier standpoint of technology.

In US Patent Publication US 2005/0 142 662-A1 it is disclosed a micro fluid analyzer with the intention of being highly sensitive, fast and very compact. The analyzer may use sufficiently low power per analysis to be easily implemented with an equivalently small battery pack or other portable power source.

It is here suggested various kinds of detectors or sensors for achieving low portability for false positives and detection versatility.

FIG. 2 is illustrating details of a micro gas application (15). A sample stream (25) may enter input port (34) from a pipe or tube (19). It is disclosed the use of a particle filter (43) for removing dirt and other particles from the stream of fluid (25) that is to enter the apparatus (15).

A portion (45) of fluid (25) may flow through the first leg of a differential termal-conductivity detector (TCD) or other device (127), which may measure photo-ionization current and a portion (27) of the fluid (25) flows through the tube (49) to a pump (51).

Data from detectors (127,129) may be sent to controller (130), which in turn may relay data to microcontroller and/or processor (29) for processing and the result may be sent to a station (31).

FIG. 13 does illustrate that a “Si”-related, light detecting block (353) is to be coordinated with a “Si”-related, light sending or transmitting block (351) with a wall element (355) adapted to guide the gas for evaluation.

Patent publication US-5 834 777-A1 is disclosing a miniaturized NDIR gas sensor using semiconductor micromachining techniques from a semiconductor material such as “Si” or “GaSa”.

Such a NDIR gas sensor comprises an optical waveguide, a light source at one and of the waveguide, at least one light detector at the end of the waveguide opposite the light source, a diffusion type gas sample chamber formed within the waveguide and interposed in an optical path between the light source and light detector so that the light source and the light detector are termally isolated from the gas sample, and a separate bandpass filter interposed between the light source and each light detector.

This miniaturized NDIR gas sensor may also be provided with the light source and the light detector on the same end of the optical waveguide.

Because the NDIR sensor is fabricated out of a semiconductor material the source drive and signal processing electronics may be added directly to the sensor using integrated circuits fabrication techniques.

Particles and smoke and dust may be kept out of the sample chamber by application of a gas permeable membrane over apertures in the sample chamber walls.

A top substrate (42) and a bottom substrate (44) are micromachine from a semiconductor material so when the top substrate (42) is attached to the bottom substrate (44) an optical waveguide (30) is formed and these substrates are attached to each other using standard die-attaching process.

Patent publication US-5 852 308-A is disclosing a micromachined integrated opto-termal sensor having a rapidly intensity varying or pulsing light source, an interference filter, shadow masking or reflective blocking of light from termal sensors or differential operation, a gas cavity into which the detected gas can flow into via a channel or filter, and a termal detector element to sense the heating of the gas caused by absorption of light at a particular wavelength by the specific gas to be detected.

A ration of the signal from the detectors may be calculated for determining the presence of gas or fluid.

The detector may have only a single cavity with two groups of termal sensors and each groupe of sensors receives radiation filtered by an interference filter which passes radiation of one wavelength for one groupe and of another wavelength for the other groupe.

The ratio of the resultant signals from the two groups of termal sensors, respectively, is calculated to determine the presence of gas in the near ambient environment of the detector.

### Definitions Concerning the Terms Chosen in the Following Description.

Discrete unit: A discrete unit indicated by the present invention is to be considered as an IC-circuit or a hybrid circuit and is to comprise, on one and the same or individual surface sections, first and second means and/or to support a third means as well as to comprise the whole of or parts of a control unit and the whole of or parts of required calculating circuits with associated memory circuits having the same or different memory capacities. The third means can be integrated in the discrete unit but is normally comprised of a unit separated from the discrete unit. However, this unit is to be able to cooperate with the discrete unit for forming a required optical measuring distance or path.

“Small thermal mass”: A material in a discrete unit and its density is to be chosen from a ceramic material or a plastic structure, which is to exhibit a limited surface extension and a limited thickness so as to be able to offer a low weight of the used material. As a suggestion, such a discrete unit can be allotted the external dimensions of 12×8×1.5 millimeters. For this purpose the discrete unit can be mounted to its support or printed circuit card over support or electrically connecting points.

“A first contact means”: A discrete unit is to exhibit a plurality of first connecting means for connecting, over an internal conductor system, on the one hand the first and the second means with the part of the control unit and/or the part of the memory circuit, which is related to the discrete unit in order to create possibilities of connection to the peripheral circuit positionings of the unit on the utilized carriers.

“Control unit”: A unit which can activate and control electric pulsing of the light-generating means and which can sense and receive thus generated pulses of light which over calculating circuits enable the calculating and determining of the existence of a gas and/or the concentration of the gas, by means of a spectral analysis known per se.

“Presentation unit”: A unit which in plain language presents the structure and concentration of the gas by means of the result of a spectral analysis, which has been carried out and determined. Such presentation unit does not necessarily have to consist of a screen, which may be viewed ocularly and could very well instead comprise generating a significant electric signal for controlling one or more functional units.

### STATEMENT OF THE PRESENT INVENTION

### Technical Problem

If the circumstance is noted, that the technical considerations that a person skilled in the art will have to carry out in order to offer a solution to one or more given technical problems are on the one hand initially a necessary understanding of the measures and/or the sequence of measures which will have to be carried out and on the other hand a necessary choice of the one or more means which are required, the following technical problems should be relevant in producing and evaluating the present object of invention in view of the above.

Considering the earlier standpoint of technology as it has been described above it must therefore be considered to be a technical problem to understand the significance of, the advantages related to, and/or the technical measures and considerations which will be required for effectively utilizing the advantages of measuring technology which are attributed to forming an integrated gas sensor component in which all significant and specific identities are built into one and the same small component which may be mounted on a surface.

There is a technical problem in being able to understand the significance of, the advantages related to, and/or the technical measures and considerations that will be required for being able to offer, by means of a discrete unit with a built-in third means or preferably adapted for supporting a separately produced third means, a more exact measuring results.

There is a technical problem in being able to understand the significance of, the advantages related to, and/or the technical measures and considerations that will be required for being able to offer a discrete unit exposing the features now entered into the preamble of the attached claim 1.

There is a technical problem in being able to understand the significance of, the advantages related to, and/or the technical measures and considerations that will be required for being able to offer a discrete unit produced with an ambition of exposing as small or restricted mass as practically is possible.

There is a technical problem in being able to understand the significance of, the advantages related to, and/or the technical measures and considerations that will be required for in addition being able to offer an increased temperature range of operation.

There is a technical problem in being able to understand the significance of, the advantages related to, and/or the technical measures and considerations that will be required for being able to offer a moisture and condense resistant detector as a discrete unit, i.a. by being able to accept an increased operating temperature.

There is a technical problem in being able to understand the significance of, the advantages related to, and/or the technical measures and considerations that will be required for being able to offer an exact positioning of the first and second means (emitter/detector) in the component or the discrete unit, such as in a narrow range, such as ±0.1 millimeters, to be compared to that an otherwise common signal spreading, such as because of metalizing, can result in an uncertainty of approximately 20%, a mounting can create an uncertainty of approximately 200% and a filament tolerance can provide an uncertainty of approximately 250%.

There is a technical problem in being able to understand the significance of, the advantages related to, and/or the technical measures and considerations that will be required for being able to offer over a discrete unit substantially better product uniformity in the signaling respect and thereby to offer a more exact process supervision/statistical one, and/or a process optimizing, and wherein anomalia will be capable of being discovered easier and quicker so as to create prerequisites for a more even production result having a higher yield, etc.

There is a technical problem in being able to understand the significance of, the advantages related to, and/or the technical measures and considerations that will be required for herein being able to offer a mechanically and environmentally more stable product with regard to the discrete unit.

There is a technical problem in being able to understand the significance of, the advantages related to, and/or the technical measures and considerations that will be required for herein being able to offer the possibility of an increased temperature stabilizing, particularly directed to the opto-electronics.

There is a technical problem in being able to understand the significance of, the advantages related to, and/or the technical measures and considerations that will be required for being able to offer a simplified calibration process, if desired a process which can be performed entirely without temperature cycles that will be necessary otherwise.

There is a technical problem in being able to understand the significance of, the advantages related to, and/or the technical measures and considerations that will be required for utilizing the production-associated and logistic advantages which are to be referred to an integrated gas sensor component, in which all significant and specific functional units can be included in one and the same small surface-mountable component in the form of a “discrete unit”.

There is a technical problem in being able to understand the significance of, the advantages related to, and/or the technical measures and considerations that will be required for creating the characteristics which are necessary in order to keep the production costs low.

There is a technical problem in being able to understand the significance of, the advantages related to, and/or the technical measures and considerations that will be required for utilizing the advantages of automatic mounting of discrete units, even if all critical components in addition will be capable of being utilized in one and the same accumulated processing step.

There is a technical problem in being able to understand the significance of, the advantages related to, and/or the technical measures and considerations that will be required for being able to utilize the advantage that a feedback time for discovering a component or process problem can become shorter, as the sensitive production steps occur first in the production chain.

There is a technical problem in being able to understand the significance of, the advantages related to, and/or the technical measures and considerations that will be required for being able to utilize the characteristic that forced yield losses solely will be able to be related to and/or affect this component or discrete unit and not as today the whole product.

There is a technical problem in being able to understand the significance of, the advantages related to, and/or the technical measures and considerations that will be required for being able to utilize the characteristic that a small number of variant components for the gas sensors provides advantages in volume and economy in automation and particularly if the produced discrete unit lacks the third means, which is to be mounted in a later step in the process.

There is a technical problem in being able to understand the significance of, the advantages related to, and/or the technical measures and considerations that will be required for being able to utilize the advantage that each chosen size of the relevant system of production can be simplified highly and shrunk down to a size produced in an IC-component characterizing machine, adopting a fewer number of operators and operations.

There is a technical problem in being able to understand the significance of, the advantages related to, and/or the technical measures and considerations that will be required for being able to utilize the advantage that a turnaround speed will be much shorter (perhaps minutes instead of many days) as i.a. the internal thermal mass has to be chosen much smaller than in known technology and that each temperature cycle therefore will occur faster.

There is a technical problem in being able to understand the significance of, the advantages related to, and/or the technical measures and considerations that will be required for being able to utilize the advantage that a temperature scanning for characterizing a component can be offered by means of a chip-on-card resistor in the component or the discrete unit instead of utilizing a complete environmental chamber.

There is a technical problem in being able to understand the significance of, the advantages related to, and/or the technical measures and considerations that will be required for letting a component insight be physically collected in an offered component or discrete unit, which is adapted to and can be automatically mounted in each standard SMD-line of a subcontractor/-customer.

There is a technical problem in being able to understand the significance of, the advantages related to, and/or the technical measures and considerations that will be required for letting occurring yield losses be concentrated to the manufacturer of the discrete unit and therefore not be noted outwards and do not affect a produced final product.

There is a technical problem in being able to understand the significance of, the advantages related to, and/or the technical measures and considerations that will be required for being able to offer complete-characterized and/or pre-calibrated components or discrete units to “just any-one”, whom without having to have any insight regarding the measuring of gas and its technology can produce good final products.

There is a technical problem in being able to understand the significance of, the advantages related to, and/or the technical measures and considerations that will be required for letting a gas-sensor related arrangement with a first means generating light, a second means receiving light and a third means for forming and defining an optical measuring distance or path between said first means and said second means through a sample of gas as well as a control unit with associated calculating circuits, memory circuits, and in which said first, second and third means are coordinated to a first unit, said mentioned unit being allotted a plurality of first electric connectors, said connectors being adapted and distributed along a first surface portion of the mentioned unit, for an electric connecting possibility to second electric connectors related to a carrier, such as a printed circuit card or board, for said unit, said first and second means being fashioned or structured as circuit arrangements of said unit and being positioned on opposite sides of said third means, indicate that said first, second and possibly third means are to be closely related or adjacently related to each other within a unit shaped as a “discrete unit” as a first and second surface section and that said discrete unit is to be shaped and dimensioned with a small total thermal mass.

There is a technical problem in being able to understand the significance of, the advantages related to, and/or the technical measures and considerations that will be required for at least letting a portion of said control unit with associated memory circuits and calculating circuits be coordinated with said discrete unit and be connected to chosen first electric connectors wiring coordinated to the discrete unit.

There is a technical problem in being able to understand the significance of, the advantages related to, and/or the technical measures and considerations that will be required for having stored in said memory circuits, in the form of one or more memory units and accessible to the control unit and the calculation unit, at least information related to a chosen application, and a structure and/or position allotted to the second and the third means on a surface portion or a surface section.

There is a technical problem in being able to understand the significance of, the advantages related to, and/or the technical measures and considerations that will be required for letting said memory circuits and part of the control unit with associated calculating circuits be related to said discrete unit as a circuit structure in a fourth surface section.

There is a technical problem in being able to understand the significance of, the advantages related to, and/or the technical measures and considerations that will be required for letting said memory circuits in the form of one or more memory units and/or said control unit with its associated calculating circuits be related to said carrier or printed circuit card over wiring and selected first and second connecting means coordinated with the discrete unit.

There is a technical problem in being able to understand the significance of, the advantages related to, and/or the technical measures and considerations that will be required for letting the first means and its surface section be comprised of a micro-produced pulsible IR-source having a high intensity at each pulse and being pulsible over chosen frequencies within a chosen frequency range.

There is a technical problem in being able to understand the significance of, the advantages related to, and/or the technical measures and considerations that will be required for letting said discrete unit be adapted, as its third means, to be able to exhibit or support a cover having a light-reflecting surface for forming an optical measuring distance facing said first and second means.

There is a technical problem in being able to understand the significance of, the advantages related to, and/or the technical measures and considerations that will be required for letting said first and second means be placed or be placeable each in individual open grooves in said discrete unit and a separate third means being adapted to cooperate with said grooves.

There is a technical problem in being able to understand the significance of, the advantages related to, and/or the technical measures and considerations that will be required for letting said discrete unit be associated with separate means so as to thereby be able to create stabilizing of the temperature.

There is a technical problem in being able to understand the significance of, the advantages related to, and/or the technical measures and considerations that will be required for letting an identification valid for the discrete unit be presentable to one or more carrier-related circuit groups, such as over said first and second electric connectors or alternatively an identification which may be fed into a circuit set-up.

### THE SOLUTION

As its starting point the present invention takes the known technology mentioned by way of introduction with a gas sensor arrangement having a first means adapted for generating light, a second means adapted for receiving light, and a third means adapted for forming and defining an optical measuring distance between said first and second means, allotted by a sample of gas, and a control unit with associated memory circuits and/or calculating circuits, said first, second and third means being able to be coordinated to a unit, said unit being allotted a plurality of first electric connector devices, said connector devices being adapted and distributed along a surface portion of said unit so as to provide an electric connecting possibility to other electric connector devices related to a carrier, such as a printed circuit card, for said unit, said first and second means being fashioned as circuit arrangements of said unit and disposed on opposite sides of said third means.

In order to be able solve one or more of the technical problems mentioned above the present invention more specifically indicates that the known technology is to be supplemented by letting said first and second means be closely related to each other within a “discrete unit” such as a first and second surface section, that said discrete unit is shaped and dimensioned so as to exhibit a small thermal mass and that at least a part of a memory circuit or a memory unit and at least a part of said control unit with associated calculating circuits are coordinated to said discrete unit and are connected to chosen first electric connecting means by means of wiring coordinated to the discrete unit.

Such as proposed embodiments falling within the frame of the basic concept of the present invention it is additionally indicated that in said memory circuit there is to be stored at least information related to a chosen application and a structure and/or position allotted to the first, second and third means.

Said memory circuit and a part of the control unit with associated calculating circuits can then be related to said discrete unit, such as a circuit structure, in a fourth surface section.

Said memory circuit and/or said control unit can be related entirely or partly to said carrier or printed circuit card over a chosen wiring coordinated with the discrete unit and over said first and second connector means.

It is particularly indicated that the first means and its first surface section is to consist of a micro-produced pulsible IR-source of high intensity and readily being pulsible over chosen frequencies.

Said discrete unit is to be adapted for exhibiting as its third means a cover having a light-reflecting surface facing said first and second means, wherein said cover may be adapted to support a third means as an individual unit.

Said first and second means can to advantage be placed in individual grooves in said discrete unit.

Said discrete unit can also be allotted to one or more means so as to thereby be able to create a temperature stabilizing in a manner known per se.

An identification concerning the discrete unit is to be presentable to one or more carrier-related circuit sets over said first and second electric connector devicesor means alternatively can an identification be led directly into one or more of said circuit sets.

### ADVANTAGES

The advantages which primarily must be considered to be characterizing of the present invention and the thereby indicated specific significant characteristics are that prerequisites have been created hereby for in a gas sensor related arrangement having a first means adapted for generating light, a second means adapted for receiving light, and a third means adapted for forming and defining an optical measuring distance between said first and second means to a sample of gas, and a control unit with associated memory circuit and calculating circuits, wherein said first, second and third means can be coordinated to a unit, that unit being allotted to a plurality of first electric connector devices, said connector devices being adapted and distributed along a surface portion of said unit, for an electric connecting possibility to other electric connector devices related to a carrier, such as a printed circuit card, for said unit, said first and second means being fashioned or formed as a circuit arrangement on chosen surface sections of said unit and positioned on opposite sides of said third means, indicating that said first and second means are to be closely related to each other within a “discrete unit”, such as a first and a second surface section, and said discrete unit is to be shaped and dimensioned for exhibiting a minimized and small thermal mass as compared to necessary circuit arrangements and chosen functions.

The entire or at least a portion of a memory circuit, the entire or at least a portion of said control unit and all or at least portions of associated calculating circuits are to be coordinated in said discrete unit and are to be connected over a coordinated internal wiring to the discrete unit, connected to chosen first electric connector devices or means and thereby accessible for one or more external function units or function circuits related to the carrier or printed circuit card.

The subject matter that primarily must be considered to be characterizing of the present invention is disclosed in the characterizing part of the following claim 1.

### SHORT DESCRIPTION OF THE DRAWINGS

A presently proposed embodiment exhibiting the significant characteristics associated with the present invention will now be described more specifically with the purpose of exemplification with reference to the accompanying drawings, in which:

FIG. 1 shows a perspective view of a gas sensor related arrangement known in the prior art and related to a printed circuit card or board and adapted for detecting the presence of a gas in a measuring cell and for over a control unit via necessary calculating circuits and memory circuits determining the structure and concentration of the gas with the assistance of spectral analysis.

FIG. 2 shows a perspective view of a first portion of a “discrete unit” exhibiting the peculiarities of a first embodiment associated with the present invention.

FIG. 3 shows a perspective view of a second portion (a lid) of the “discrete unit” in accordance with FIG. 2, wherein the first portion and the second portion are adapted to cooperate with each other for forming a closed complete “discrete unit”.

FIG. 4 shows a side view of the basic construction of a discrete unit in accordance with the invention.

FIG. 5 shows the discrete unit, according to FIG. 4, in a proposed encapsulated embodiment.

FIG. 6 shows in a perspective view a first means generating light in a particularly proposed embodiment for the basic construction of the invention without utilizing a filament actuated by electric pulses.

FIG. 7 shows a graph over the depth of a modulation as a function of a chosen frequency of the first means, according to FIG. 6, and with a frequency rang, which is significant for the invention.

FIG. 8 shows a lower surface portion of a discrete unit of a second embodiment with exposed first electric connector devices or means edgewise oriented.

FIG. 9 shows an upper, second surface portion of a discrete unit having therein formed first and second means (the third means has been removed or delete for clarification) of the embodiment of FIG. 4, wherein the second surface portion can be covered by a lid, such as a lid shown in FIG. 3.

FIG. 10 shows a lateral view of a third proposed embodiment of the discrete unit and with the third means positioned below the carrier of the discrete unit.

FIG. 11 shows a lateral view of an embodiment, according to FIG. 10, in an encapsulated embodiment, and

FIG. 12 basically illustrates, in the form of a block diagram, a proposed embodiment of a discrete unit according to the present invention, wherein specific parts associated with the control unit, specific parts associated with the calculating circuit and specific parts associated with the memory circuit and functions are separated from the control unit and distributed to a printed circuit card supporting the discrete unit as well as a proposed alternative.

### DESCRIPTION OF KNOWN TECHNOLOGY

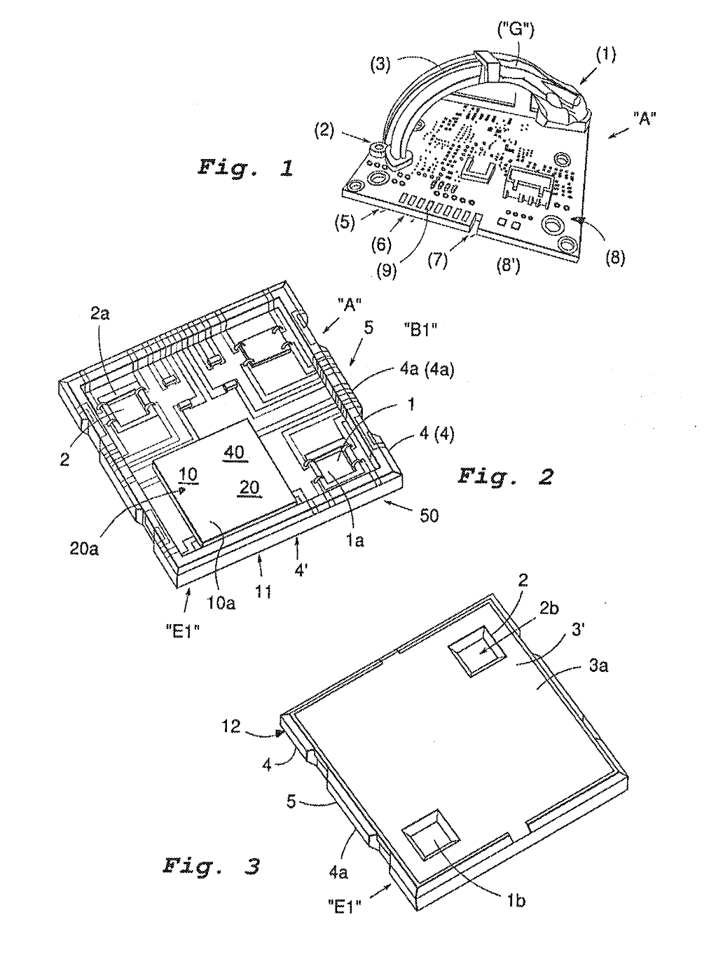

With reference to FIG. 1, the latter shows in a perspective embodiment an earlier known gas sensor related arrangement disposed on a printed circuit card or board and having an optical measuring distance in the form of a convex arc.

Said arc is shaped as a part of a torus, but open downwardly, and supported by a printed circuit card, with which various functional units are coordinated, such as circuits and components, for a control unit with pertinent memory circuits, a central unit, and calculating circuits in order to be able to evaluate the existence of and the concentration of a chosen gas in a gas sample located within the optical measuring distance for a spectral analytic evaluation in a manner known earlier per se.

Thus FIG. 1 shows a gas sensor related arrangement “A” having a first means (1) adapted for generating light, a second means (2) adapted for receiving light, and a third means (3) adapted for forming and defining the optical measuring distance or path between said first (1) and second (2) means through a sample of gas (“G”).

A control unit (6) with associated calculating circuits (7) and said first (1), second (2), and third (3) means are coordinated with and all supported by a printed circuit card (8).

Said printed circuit card (8) can be allotted a plurality of electric connector devices or means (9), said connector devices being adapted and distributed along a first surface portion (5) of said printed circuit card for an electric connecting possibility to other electric connector devices or means related to a second printed circuit card (8′).

Said first (1) and second (2) means are shaped as circuit arrangements on said printed circuit card (8) and are disposed on opposite sides of said third means (3).

### Description of Each of the Embodiments Now Proposed

By way of introduction it should be mentioned that in the following description of a presently proposed embodiment, which exhibits the significant characteristics associated with the invention and which are clarified by means of FIGS. 2 to 12 in the following drawings we have chosen terms and a specific terminology with the purpose of thereby primarily clarifying the concept of the invention.

However, in this connection it should be noted that the terms chosen here are not to be seen as limiting solely to the terms utilized and chosen here and it goes without saying that each in this manner chosen term is to be interpreted in such manner that in addition it comprises all technical equivalents which function in the same or essentially the same manner so as thereby to be able to attain the same or essentially the same to purpose and/or technical result.

Thus, with reference to the accompanying FIGS. 2 to 12 not only is the present invention shown schematically and in detail but the significant features related to the invention have also been concretized by the embodiments now proposed and more specifically described in the following.

Thus, FIG. 2 shows a first portion 11 of the gas sensor related arrangement “A” structured according to the principles of the invention in a first embodiment having a first light generating means 1, a second light receiving means 2 and a third means 3 for forming and defining an optical measuring distance between said first means 1 and said second means 2 through a gas sample “G”, located in a cavity in the first portion 11 when it is covered by a lid construction 3′, according to FIG. 3.

It is noted here that the embodiment of FIGS. 2 and 3 can be shaped such, that the cavity adapted for the sample of gas “G” can be enclosed by the lid 3′.

A more sophisticated embodiment is offered if the third means is allotted a separate unit, which may be applied to surface 3a, with said separate unit defining a desired cavity with an optical measuring distance structured by reflecting light rays.

The invention indicates the existence of a control unit 20 with associated calculating circuits 30 and memory circuits 40, wherein said first 1 and second 2 means are coordinated to a first unit “E1” in the form of a “discrete unit” produced on the basis of the principles of the invention (without said third unit construction 3).

Said first portion 11 of the mentioned discrete unit “E1” is allotted a plurality of first electric connector devices or means 4, 4a, said devices here being adapted and distributed along a first surface portion 5 of said discrete unit “E1” for the possibility of being electrically connected to second electric connector devices or means (4), (4a) related to a support “B1”, such as a printed circuit card “B1”, for said discrete unit “E1”.

Said first 1 and said second 2 means are in FIG. 2 illustrated shaped as circuit arrangements 1a, 2a structured as surface sections in said discrete unit “E1” and disposed on opposite sides of or below a third means 3, when the second part 12, shown in FIG. 3, has been made to cooperate with the first part 11.

In one embodiment the part 12 can be rotated or tilted to cooperate with the first part 11 for covering the circuit arrangement, exposed in FIG. 2.

FIG. 2 illustrates that all four sides of unit “E1” are provided with first connector devices or means corresponding to connector devices or means 4, 4a of the first surface portion 5 or its edge extension.

Said first 1 and second 2 means are here very closely related to each other in the discrete unit “E1”, which for this purpose is formed with a first and a second surface section 1a, 2a.

The third unit 3 is here related to the outer surface section 3a.

Said discrete unit “E1” is shaped and dimensioned with, from the manufacturing point of view, a surface extension and other considerations, which result in a very small thermal mass.

FIG. 2 illustrates a thin plate with four edging positions.

The thermal mass is normally to be able to lie between 100 cubic millimeters and 500 cubic millimetres, multiplied by the density of the material.

A volume of between 200 and 300 cubic millimeters is preferred with an application of today's technology.

The invention is basically based on choosing the thermal mass as small as possible, but the discrete unit “E1” is to be provided with at least:
a. a first means 1,
b. a second means 2,
c. all or part of the function units of the control unit 20,
d. all or part of the necessary memory circuits 40, with an accessible memory capacity for control unit 20,
e. one or more calculating circuits 30 related to control unit 20,
f. an unambiguous identification (ID) of the discrete unit “E1” for interpreting functional criterions related to the discrete unit “E1”,
g. a third means 3 can be enclosed in the discrete unit “E1” or alternatively be applied as a separate unit to unit “E1” or be disposed in other manner close to unit “E1”.

More particularly it is indicated that memory circuit 40, the entire control unit 20 and all of the calculating circuits 30 are to be coordinated in said discrete unit “E1”. Identifying the discrete unit “E1” with or without a chosen third means 3 is simplified through this.

Coordinated internal wiring to the discrete unit “E1” is to be connected to chosen first electric connector devices, which here are illustrated as connector devices or means 4, 4a.

As a memory unit 10 inside of said memory circuit 40 there are stored at least one piece of information related to a chosen application and a structure and/or position allotted to the second 2 and the third 3 means and limited to a surface portion 10a.

Memory unit 10 and part of control unit 20 with associated calculating circuits 30 can be related to said discrete unit “E1” as a circuit structure in a detached fourth surface section 20a, for example part of surface section 10a.

Memory unit 10 and its memory circuits 40 and/or said control unit 20 can as an alternative be more or less related to said carrier “B1” or printed circuit card over a jumper between the first 4, 4a and the second (4), (4a) connecting devices.

The first means 10 and its first surface section 1a can to advantage consist of a micro-mechanically produced pulsible IR-source with a high intensity of each pulse and pulsible over chosen frequencies falling within a specifically chosen frequency range.

Said discrete unit “E1” is adapted for exhibiting, as a third means 3, a lid construction 12 having a light-reflecting surface 3a facing away from said first 1 and second 2 means for supporting said third means 3 as a separate unit, which utilizes light rays reflected in wall portions and in said surface 3a for forming the optical measuring distance or path.

The first 1 and second 2 means are here to be placed in individual grooves 1b, 2b or windows, usually provided with filters in said discrete unit “E1”.

In addition, the discrete unit “E1” is allotted means 50 so as thereby to be able to stabilize the temperature.

An identification “ID”, valid for the discrete unit “E1”, may be presented to one or more carrier-related “B1”-circuit sets over a third electric connector device or means 4b, (4b).

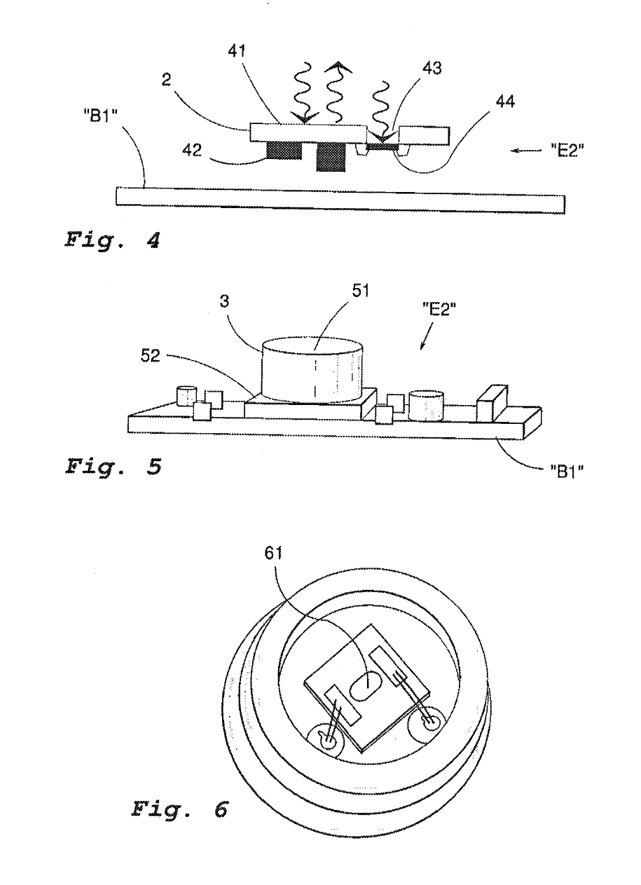

With reference to FIG. 4, the latter shows an arrangement “E2” having an optical mirror surface 41, with a memory circuit 42 and an optical filter 43 adjacent to an IR-detector 44, supported by a carrier “B1”.

FIG. 5 illustrates the arrangement of FIG. 4 encapsulated with an optical covering 51 forming the third means 3, components 52 for the transmitting and receiving circuits of sensor “E2” and the other electronics.

FIG. 6 illustrates a light source 61 produced by micro-technology for light pulsing and having high intensity and with built-in possibilities of choosing an adapted pulse sequence.

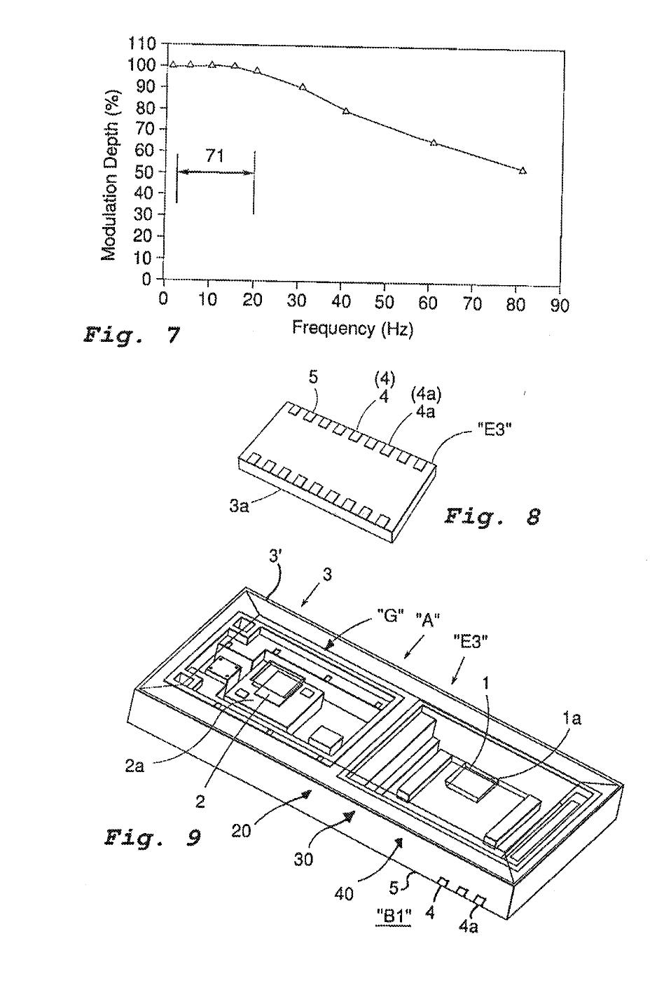

The modulation depth (in %) related to the chosen frequency (Hertz) is illustrated in the graph of FIG. 7, only as an illustrating example.

The present invention is intended to be using up to 40 Hertz according to FIG. 7 and up to 20 Hz as the marked-out portion 71 thereof.

In FIG. 6 the existence of a freely hanging membrane 61 with a surface spread of 1.7×1.7 square millimeters and with the hottest point with a received electric pulse is illustrated exhibiting a maximized temperature of around 750° C.

FIGS. 8 and 9 have the purpose of illustrating an additional embodiment of the present invention, this one also formed as a discrete unit “E3”.

Here, also, the discrete unit “E3” in the form of an integrated gas sensor component is illustrated, with all specific parts and functions being built-in and concentrated to one and the same little surface-mountable component (12×8×2 cubic millimeters).

The gas-sensor related arrangement “A” shown here has a first light-generating means 1, a second light-receiving means 2 and a third means 3, not shown, for forming and defining an optical measuring distance between said first 1 and second 2 means by a gas test “G”, and a control unit 20 with associated calculating circuits 30 and memory circuits 40.

Said first 1 and second 2 means are also here coordinated to one single discrete unit “E3”.

Said discrete unit “E3” is allotted to a plurality of first electric connector devices 4, 4a, said connector devices being adapted and distributed along a first surface portion 5 of said unit for an electric connecting possibility to other electric connecting devices (4), (4a) related to a support “B1”, such as a printed circuit card.

Here, too, said first 1 and said second 2 means are shaped as circuit arrangements of said discrete unit “E3” and disposed on opposite sides of and/or covering a third means 3.

Said first 1 and second 2 means are closely related to each other in the discrete unit “E3” as a first and second surface section 1a, 2a, respectively.

The discrete unit “E3” is also here shaped and dimensioned with a small thermal mass (12×6×2 cubic millimeters) and at least part of a memory circuit 40 and/or memory unit 10, at least part of said control unit 20, and at least chosen functions within associated calculating circuits 30 are coordinated with said discrete unit “E3” and can be connected over internal wiring coordinated with the discrete unit to said first electric connecting device 4, 4a.

The unit “E3”, in FIG. 9, can to advantage be covered by a lid arrangement 3′, according to FIG. 3, but also with another surface extension.

FIG. 10 illustrates a section through a discrete unit “E4” with a first means or a transmitter 101 and a window 102 as well as a second means or detector 103 precoupled by a filter 104 and with a third means 3.

A circuit arrangement is also related to this discrete unit “E4”, such as memory circuits 105, operational amplifier 106 and the like.

The unit “E4” is disposed on a carrier “B1” over an air gap 110 and with grooves 111, 112 through the carrier for supporting said third means 3 on the underneath side.

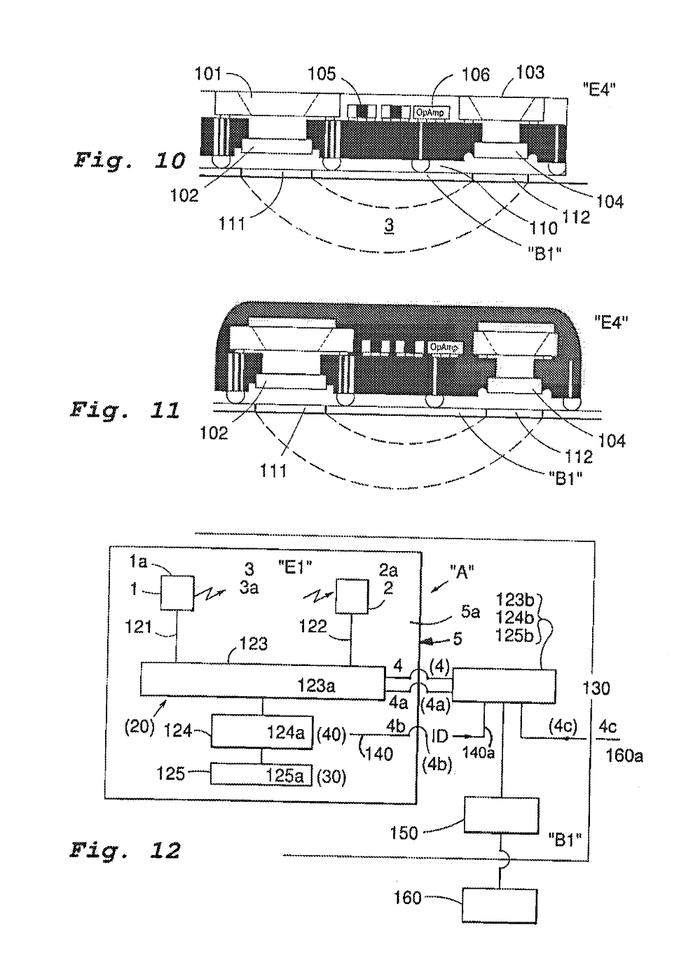

FIG. 11 illustrates that unit “E4”, according to FIG. 10, is encapsulated but adapted for Flip-Chip-mounting on a carrier “B1”.

FIG. 12 illustrates in the form of a block diagram the manner in which the surface sections 1a and 1b are connected to a control unit 123 (20) with associated memory circuits 124 (40) and calculating circuits 125 (30) by means of internal wiring 121, 122.

The entire control unit 123 or only part of the functions 123a of control unit 20, the entire memory circuit 124 or only part of the memory circuits 124a and/or all the calculating circuits 125 or solely part of the calculating circuits 125a are related to said discrete unit “E1”, such as a circuit structure in a fourth surface section 5a.

Hence, the entire or solely a remaining part of the functions 123b, the entire or only a remaining part of the memory circuits 124b and/or the entire or a remaining part of the calculating circuits 125b can be related to one or more circuit sets 130 formed in the carrier “B1”.

An ID-signal 140 is connected to the connecting device (4b) over connecting device or means 4b to circuit set 130 for unitarily transferring by means of this signal 140a significant signal structure informing the circuit setting 130 of the specific prerequisites that apply to the chosen discrete unit “E1”.

To advantage, these specific prerequisites can be:
a. parameters applicable to a chosen gas,
b. parameters applicable to a chosen gas concentration,
c. parameters applicable to a temperature dependency,
d. parameters applicable to a compensation of evaluating measuring parameters, and/or
e. parameters applicable to a relevant environment.

FIG. 12 illustrates the utilization of an adaptation circuit 150 to a display unit 160 or equivalent.

Over an external signal 160a through a wiring 4c and (4c) an ID-signal corresponding to a chosen circuit structure for the discrete unit “E1” and/or a chosen third means 3 can be transferred to the circuit set 130.

The invention is naturally not restricted to the embodiment disclosed above as an example and it can be subject to modifications within the frame of the inventive concept illustrated in the subsequent claims.

It should particularly be noted that each shown unit and/or circuit can be combined with each other shown unit and/or circuit within the frame of being able to achieve the desired technical function.

1. A gas-sensor related arrangement with a first light-generating element, a second light-receiving element and a third element for forming and defining an optical measuring distance or path between said first and second elements through a gas sample, as well as a control unit, with associated memory circuits and calculating circuits, wherein said first, second, and third elements can be coordinated to a unit, said unit being allotted a first plurality of electric connector devices or elements, said connector devices being adapted and distributed along a first surface portion of said unit for an electric connecting possibility to other electric connector devices or elements related to a carrier, such as a printed circuit card, of said unit, wherein said first and said second elements are formed as circuit arrangements of said unit and are disposed on opposite sides of said third element, wherein said first and second elements are closely related to each other within a discrete unit and are there shaped as a first and a second surface section, that said discrete unit in addition is formed and dimensioned with a small thermal mass, that the entire or at least part of the memory circuit, the entire or at least part of the control unit, and/or all or at least part of the associated calculating circuits are coordinated in said discrete unit and that over an internal wiring coordinated with the discrete unit these are connected to chosen first electric connecting devices or elements.

2. Arrangement in accordance with claim 1, wherein in said memory circuit there is stored at least information relating to a chosen application and a structure and/or a position allotted to the first, the second, and the third elements.

3. Arrangement in accordance with claim 1, wherein said memory circuit and part of the control unit with associated calculating circuits are related to said discrete unit as a circuit structure in a fourth surface section.

4. Arrangement in accordance with claim 1, wherein said memory circuit and/or said control unit are related to said carrier or printed circuit card over an internal wiring coordinated with the discrete unit and a jumper between said first and second connector devices.

5. Arrangement in accordance with claim 1, wherein the first element and its first surface section consist of an -source (InfraReed) pulsed over micro-technology, having high intensity and being pulsable over chosen frequencies.

6. Arrangement in accordance with claim 1, wherein said discrete unit is adapted for, as its third element, exhibiting a lid construction having a light-reflecting surface facing said first and second elements and with the remainder of said third element being formed as a separate unit.

7. Arrangement in accordance with claim 1, wherein said first and second elements are placed in individual recesses in said discrete unit and/or carrier.

8. Arrangement in accordance with claim 1, wherein said discrete unit is allotted means so as to thereby be able to create stabilizing of the temperature.

9. Arrangement in accordance with claim 2, wherein an identification applicable to the discrete unit is presentable to one or more carrier-related circuit sets over said first and second connector devices or elements.

10. Arrangement in accordance with claim 9, wherein the identification is carried out over said first and second electric connector devices or elements.

11. Arrangement in accordance with claim 9, wherein the identification occurs externally of the carrier-related circuit set.
